(19) United States
(12) Patent Application Publication
(10) Pub. No.: US 2009/0084486 A1
(43) Pub. Date: Apr. 2, 2009

(54) OPTIMIZED ORDERING OF DOUBLER PLIES IN COMPOSITE STRUCTURES

(75) Inventors: Wei-Pai Tang, Redmond, WA (US); Michael R. Chapman, Federal Way, WA (US); Robert A. Kisch, Auburn, WA (US)

Correspondence Address: TUNG & ASSOCIATES / RANDY W. TUNG, ESQ., 838 W. LONG LAKE ROAD, SUITE 120, BLOOMFIELD HILLS, MI, 48302, US

(73) Assignee: The Boeing Company

(21) Appl. No.: 11/862,350

(22) Filed: Sep. 27, 2007

(51) Int. Cl. B32B 37/12; G06F 19/00; G06Q 10/00

(52) U.S. Cl. 156/64; 700/108; 705/30; 705/32

(57) ABSTRACT

The off-part motion of an automatic composite tape laydown head is optimized to increase the overall rate at which tape is laid down to form doublers in a composite structure layup. Starting and stopping gates for each doubler are determined based on ply data and course definitions for the doublers. Using the gate locations, multiple possible paths between the doublers are analyzed to determine the best course for optimizing tape head travel. The selected course is used by an NC program that controls the operation of the tape head.

### TECHNICAL FIELD

This disclosure generally relates to methods and machines for automated fabrication of composite structures, and deal more particularly with a method for minimizing the off-part motion of an automatic tape laydown head used to layup doubler plies.

### BACKGROUND

Composite parts and structures such as those used in the automotive, marine and aerospace industries may be fabricated using automated composite material application machines, such as composite tape lamination machines and composite fiber placement machines, also referred to as tape laydown machines.

Some conventional composite material application machines, for example a flat tape lamination machine (FTLM) or a contoured tape lamination machine (CTLM), produce flat or gently contoured composite parts by laying relatively wide strips of composite tape onto generally horizontal or vertical tooling surfaces, such as a mandrel. Other conventional composite material application machines, for example, an automated fiber placement (AFP) machine, are used to produce generally cylindrical or tubular composite parts by wrapping relatively narrow strips of composite tape, or tows, around a rotating manufacturing tool, such as a mandrel.

Tape laydown machines may employ single or multiple composite material application heads that are operated by NC (numerical control) or computer numerical control (CNC) controllers that control movement of the head as well as ancillary functions, including applying and cutting tape “on the fly”. In aerospace applications, these machines may be used to fabricate a wide variety of composite parts, such as flat spars, stringer charges, wing skins and fuselage barrel sections, to name a few.

Composite parts of the type mentioned above comprise multiple plies of varying thickness, complexity, and in some cases, orientation. Application of the tape is broken down into sequences each of which may comprise a single ply or one or more individual pieces called “doubler” plies. The doubler plies in a layer (sequence) may have the same or different fiber orientation. All doublers laid in a sequence are normally in place on the part before tape application proceeds to the next sequence. The part is complete when all sequences have been placed.

Path generation software may be provided that automatically controls tape head movement, including the order in which doublers are laid down. The specific machine motions and tape head path controlled by the software may be determined by the software programmer based on a few simple rules, personal experience and/or intuition. In some cases, the programmer may choose a doubler ordering that is suboptimal because of wasted, off-part motion of the tape head. The process of programming the optimum tape head path is particularly challenging where the part utilizes a large number of doublers.

Accordingly, there is a need for a method of controlling a tape laydown machine that optimizes the tape head path in order to minimize off-part tape head motion and increase tape laydown efficiency. Embodiments of the disclosure are intended to satisfy this need.

### SUMMARY

Embodiments of the disclosure provide a method for achieving efficient layup ordering of pieces or doublers for each ply of a composite structure. The method may be implemented by a software program that controls the tape head of an NC composite material laydown machine in a manner that minimizes off-part motion of the tape head. By selecting an optimum path of travel between doublers, wasted, off-part motion may be reduced and composite tape may be laid down at an overall greater rate, resulting in a reduction of the time required to fabricate parts. Tape head motion is optimized by analyzing multiple travel path options, determining the off-part motion associated with each travel path option, and selecting a travel path that minimizes the off-part motion. Optimal lay-up ordering is achieved that minimizes the distance traveled by the tape head between doublers.

According to one disclosed embodiment, a method is provided for optimizing automated laydown of a plurality of composite doublers in a composite structure layup. The method comprises the steps of: selecting an order in which an automated composite tape laydown machine may lay down the doublers; determining a cost associated with the travel of the tape head required to laydown the doublers in the selected order; and, revising the order in a manner to minimize the travel cost. The travel cost may be determined by assessing the total distance traveled by the tape head to laydown the doublers using the selected order, and/or assessing the total time required for the tape head to laydown the doublers. The ordering of the doublers may include determining, for each doubler, the points at which the tape head may begin and end tape laydown. The method may further comprise generating a set of programmed instructions for controlling the movements of the tape head using the revised order for laying down the doublers.

According to another disclosed embodiment, a method is provided of optimizing the operation of an automated tape laydown head used to fabricate a composite structure. The method comprises the steps of analyzing optional paths of travel of the tape head between doublers in a sequence; identifying nonproductive motion of the tape head during travel between the doublers for each of the optional travel paths; selecting a travel path that minimizes nonproductive motion of the tape head; and, generating a set of machine readable instructions used for automatically controlling the tape head based on the selected path of travel. The nonproductive motion may be identified by determining the length of time that the tape head is not laying down tape and/or determining the total distance traveled by the tape head during movement between the doublers. Selecting the path of travel may include selecting an order in which the tape head moves between the doublers.

According to a further embodiment, a method is provided for automatic control of a composite tape laydown head used to form composite ply doublers in a composite structure layup. The method comprises the steps of: selecting, for each doubler, the location of a beginning gate and an ending gate between which the tape head lays down courses of tape; using the selected gate locations, generating a plurality of possible courses of travel of the tape head between the doublers; determining the motions of the tape head required during travel of the tape head for each of the possible generated courses; identifying which of the possible courses of travel represent the least amount of tape head motion; and, generating a set of machine readable instructions used for automatically controlling the tape head based on the identified course representing the least amount of tape head motion.

Other features, benefits and advantages of the disclosed embodiments will become apparent from the following description of embodiments, when viewed in accordance with the attached drawings and appended claims.

### BRIEF DESCRIPTION OF THE ILLUSTRATIONS

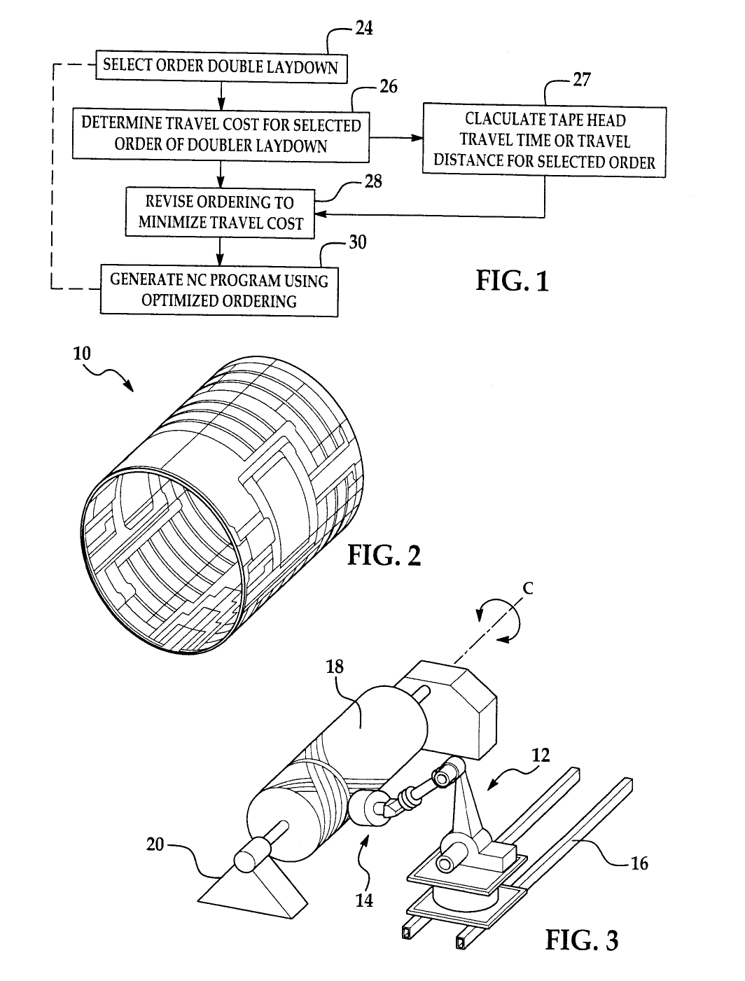

FIG. 1 is a flow diagram broadly illustrating the steps of a method for minimizing the off-part motion of an automatic tape laydown head.

FIG. 2 is an isometric illustration of an aircraft fuselage formed by sequences of composite material.

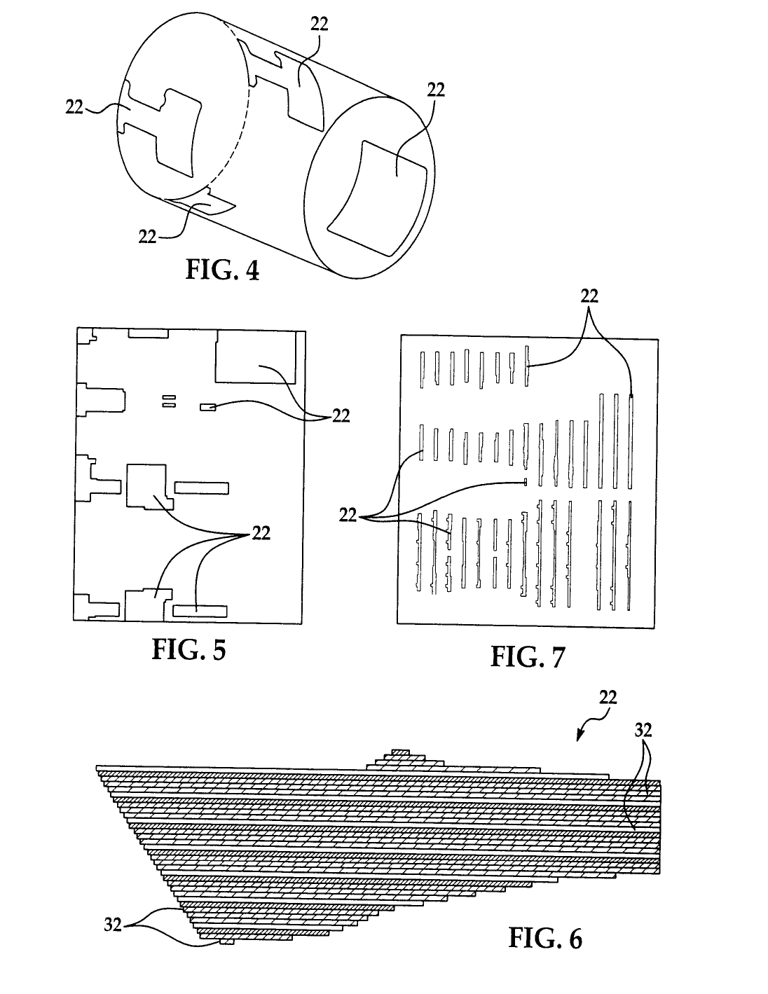

FIG. 3 is an isometric illustration of an automated tape laydown operation for fabricating the fuselage shown in FIG. 2.

FIG. 4 is an isometric illustration showing a typical cylindrical sequence of plies used in the fuselage shown in FIG. 2, including several doublers having the same tape orientation.

FIG. 5 is a planar layout of the doublers shown in the cylindrical sequence shown in FIG. 4.

FIG. 6 is a plan illustration of a doubler showing individual tape segments of that same tape orientation.

FIG. 7 is a planar layout of a cylindrical sequence of plies comprising multiple doublers.

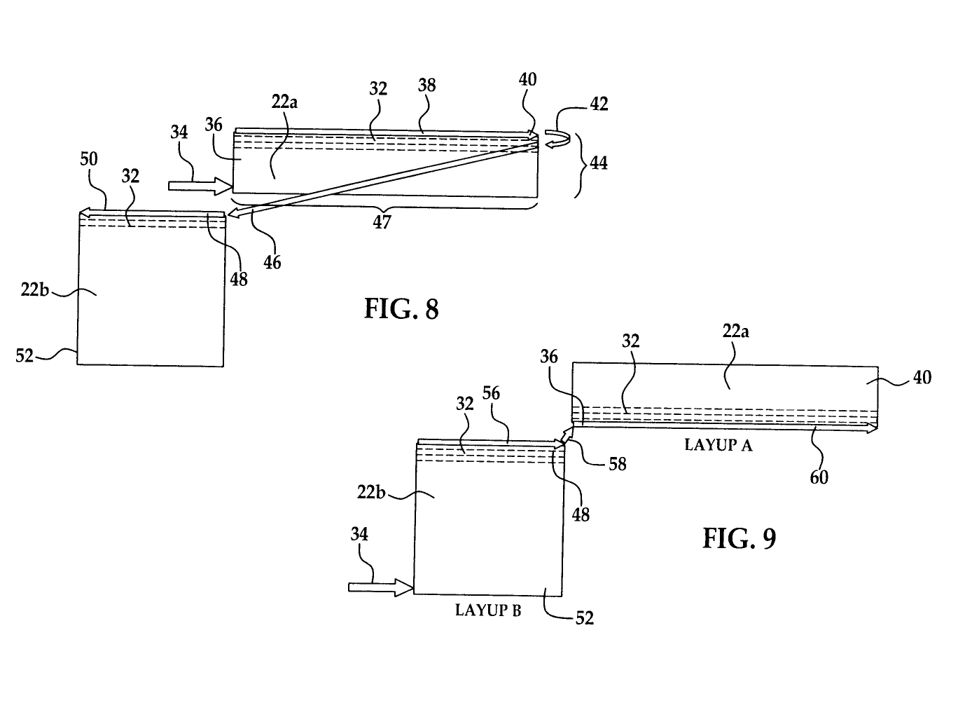

FIG. 8 is a planar layout of two lay-ups representing doublers, and showing a non-optimized tape head path that results in wasted, off-part motion.

FIG. 9 is a planar layout similar to FIG. 8 but showing an optimized tape head path that results in minimum off-part motion.

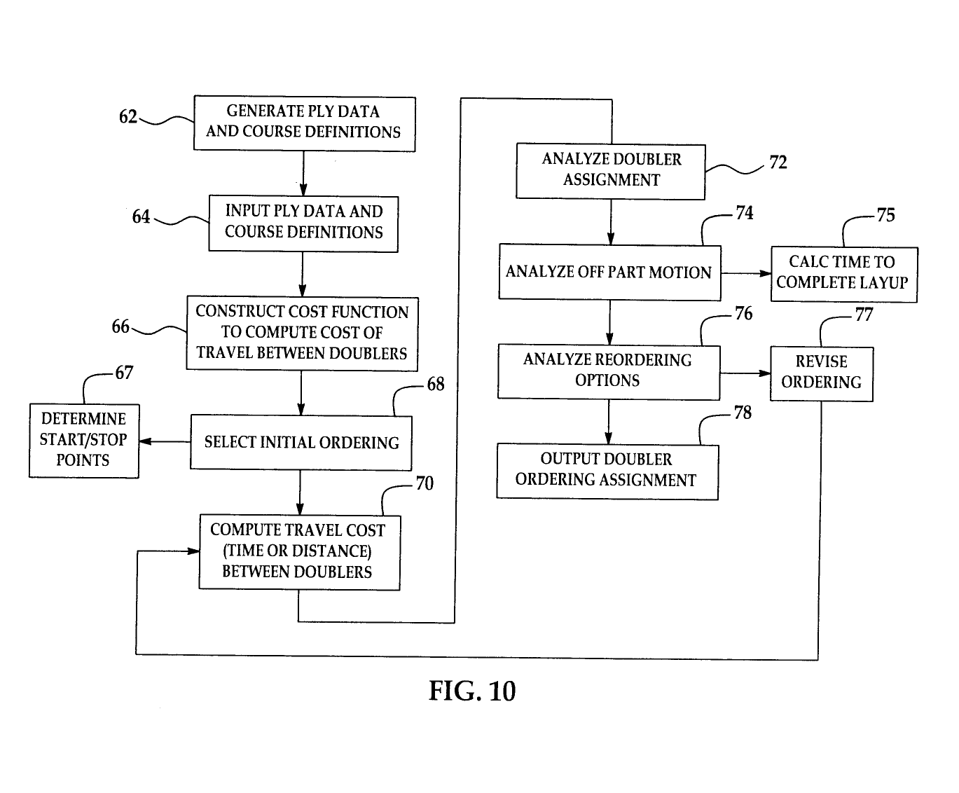

FIG. 10 is a flow diagram illustrating additional steps of a method embodiment.

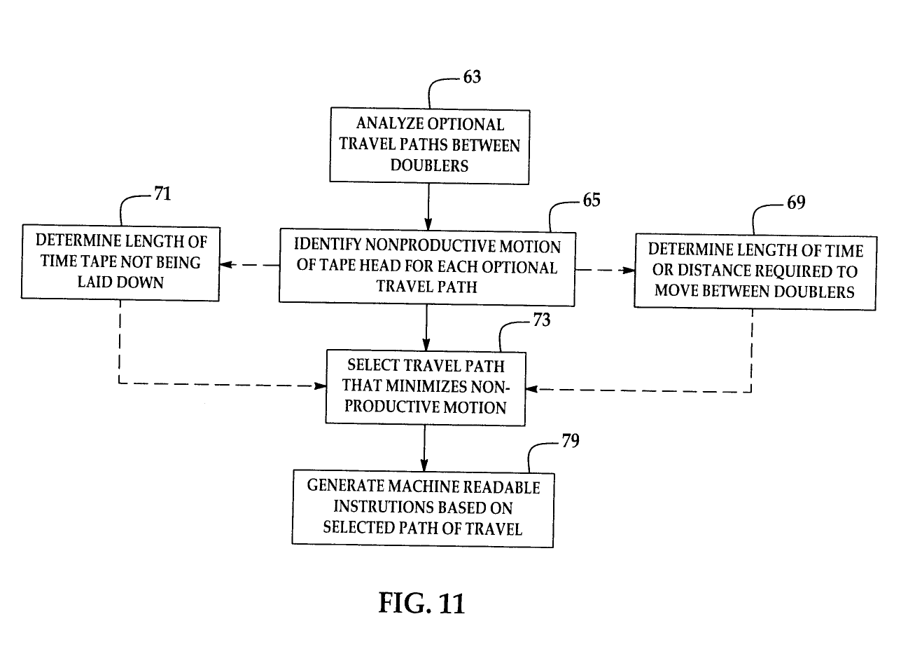

FIG. 11 is a flow diagram illustrating steps of an alternate method embodiment.

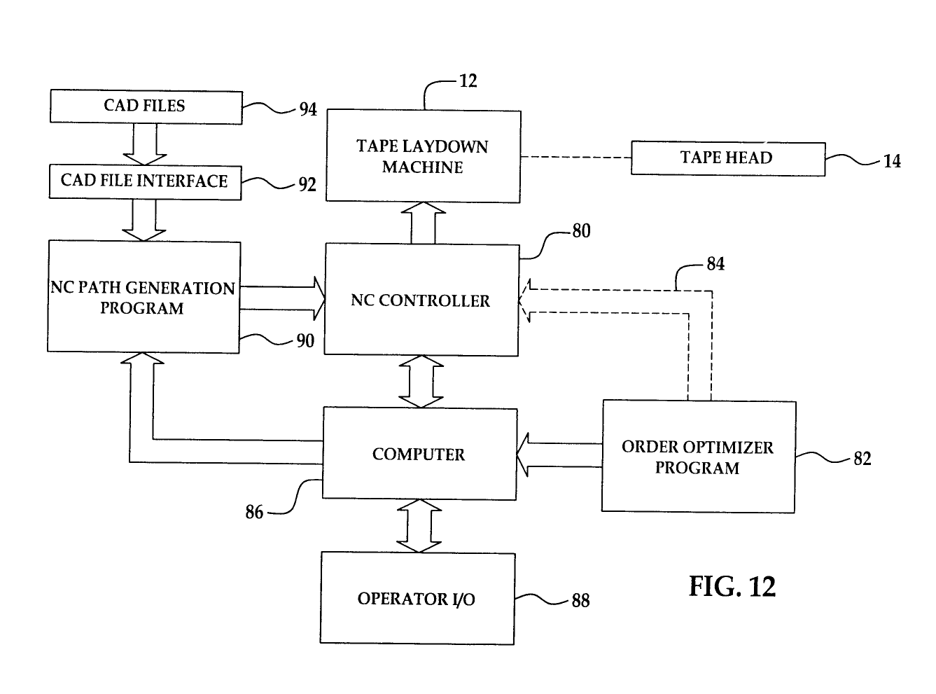

FIG. 12 is a block diagram illustration of a system for automatic control of a tape laydown machine, using an optimizer program according to the disclosed embodiments.

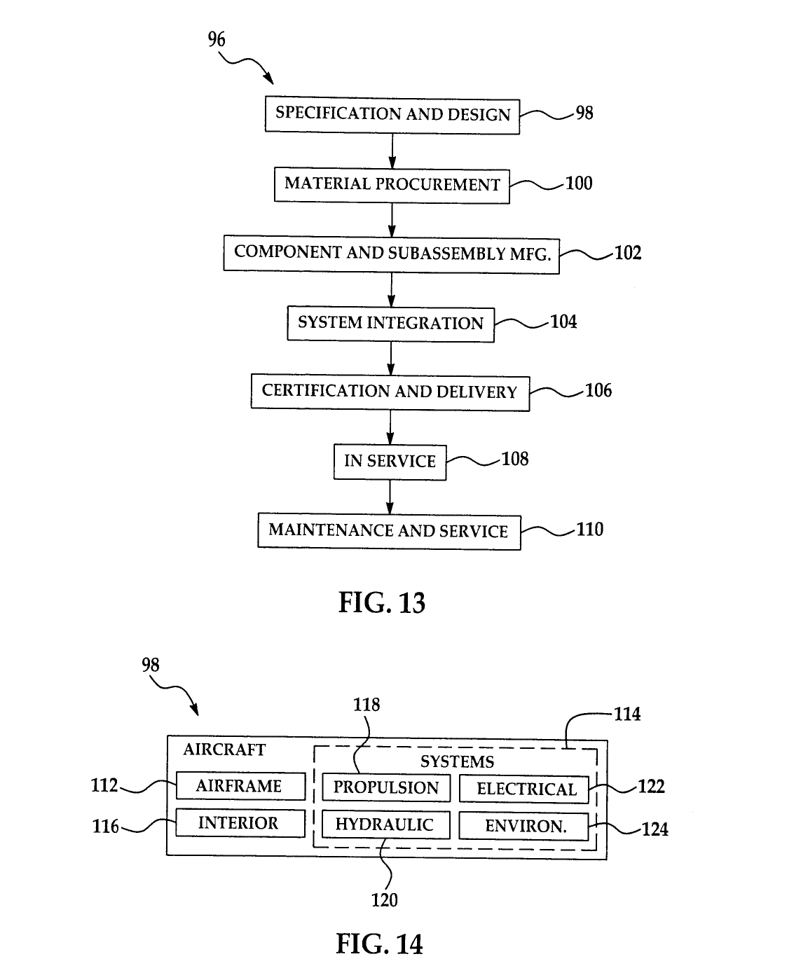

FIG. 13 is a flow diagram of aircraft production and service methodology.

FIG. 14 is a block diagram of an aircraft.

### DETAILED DESCRIPTION

Referring first to FIGS. 1-7, a composite fuselage 10 (FIG. 2) comprises a plurality of composite material sequences or layers, each containing one or more plies of composite tape. The sequences generally represent layers of composite material that form the fuselage 10, and the plies generally represent a region of a composite material layer. The plies may include one or more pieces or doublers 22 having an identical fiber orientation. For example, as shown in FIG. 6, a doubler 22 comprises multiple courses 32 of tape having a 0 degree fiber orientation.

The tape courses 32 may be laid up on a tool such as a cylindrical mandrel 18 by an automated tape laydown machine 12 mounted on tracks 16 for linear movement parallel to the axis of the mandrel 18. The laydown machine 12 may include a tape head 14 that is moveable along multiple axes to allow placement of tape at desired locations on the mandrel 18. Mandrel 18 may be mounted for rotation on supports 20 to facilitate tape application around the entire circumference of the mandrel 18. Rotation of the mandrel 18 and the operation of the laydown machine 12 may be automatically controlled by an NC (numeric control) or CNC (computer numeric control) controller 80 (FIG. 11), which includes programmed instructions for controlling tape head movement 14 as well as ancillary functions such as tape feed and tape cutoff. The tape laydown machine 12 may be of any of several types which include spools (not shown) of composite tape having a standard width such as, without limitation, three inches or six inches, or a non-standard width such as one eighth inch or one quarter inch, commonly referred to as “tows”.

Since the doublers 22 are typically spaced apart, and sometimes irregularly distributed, the tape head 14 must travel from one doubler 22 to the next, during which time the tape head 14 is nonproductive, i.e. it is not actively laying down tape. As a result, in the absence of an optimized path of travel for the tape head 14, the overall time required to complete lay-up of the fuselage 10 may be greater, particularly where the part layup includes a relatively large number of doublers 22, such as the part layup shown in FIG.7. For example, in one application involving layup of the fuselage 10, nonproductive off-part motion of the tape head 14 may comprise as much as 15% of the total time required to complete the layup.

In accordance with the disclosed embodiments, as shown in FIG. 1, the travel path of the tape head 14 may be optimized and the total off-part motion may be reduced. Beginning with step 24, one possible order is selected for laying down the doublers 22. This selected order represents one of many optional orders in which the doublers 22 might be laid down by the tape head 14. The ordering selected in step 24 may determine the length of travel of the tape head 14 between doublers, and thus the total off-part motion of the tape head 14. Having selected an initial doubling order, the next step 26 comprises determining the travel “cost” for the selected order of doubler laydown. This travel cost may be measured in terms of time, distance, or other factors calculated at step 27, which quantify off-part motion of the tape head 14. Next, at step 28, the initial laydown order selected in step 24 is revised in a manner which reduces the travel cost determined in step 26. Steps 24-28 are repeated until the travel cost is minimized, which, accordingly, represents an optimized travel path that results in the least amount of off-part motion of the tape head 14.

FIG. 8 illustrates how a non-optimized tape head path may result in nonproductive tape head motion. A pair of doubler layups 22a, 22b may be formed by the tape head 14. The tape head 14 begins laying down tape courses 32 at a starting gate 36, moving in a direction indicated by the arrow 34. The tape head 14 lays down successive parallel courses 32. The last of these courses indicated by the tape head path 38 ends at a stopping gate 40. In order to travel to the next layup 22b, the tape head 14 must reverse course as indicated by the numeral 42, and traverse along a tape head path 46 to a point corresponding to a starting gate 48 for doubler 22b. The tape head 14 then moves along path 50 to laydown the first course of tape. Successive courses 32 are laid down parallel to the path 50 until the tape head 14 reaches a stopping gate 52, thereby completing layup of doublers 22a, 22b. The tape head path shown in FIG. 8 demonstrates that the tape head 14 movement includes substantial, off-part motion. For example, when the tape head 14 reaches the stopping gate 40, it is positioned at a location most distal to doubler 22b. Moreover, the tape head 14 remains “off-part” during the U-turn motion 42. Finally, the tape head 14 must traverse the entire width 44 and length 47 of doubler 22a before it reaches the starting gate 48 for doubler 22b.

FIG. 9 illustrates a tape path that has been optimized in accordance with the disclosed embodiments, in order to lay-up doublers 22a, 22b with the least amount of off-part motion of the tape head 14. Beginning at a starting gate 52 on doubler 22b, the tape head 14 moves in the direction indicated by the arrow 54, traveling in parallel paths to laydown successive courses 32 of tape, until the final course is laid down, indicated by tape head path 56. Tape head path 56 ends at a stopping gate 48 which lies in proximity to a starting gate 36 on doubler 22a. The tape head 14 travels diagonally, only a relatively short distance along tape head path 58 to the starting gate 36. Then, the tape head 14 moves along an initial tape head path 60 to lay down the first course 32 of tape. Successive, parallel tape courses are laid down to form the doubler layup 22a, until the tape head stops at the stopping gate 40.

The wasted, off-part motion of the tape head 14 following the order shown in FIG. 8 may be determined in part by comparing the travel path 46 with travel path 58. Additionally, the return motion of the tape head 14 designated by path 42 in FIG. 8 represents additional time the tape head remains “off-part”.

Additional details of the method embodiment are shown in FIG. 10. As shown in step 62, data is generated which defines the plies and the courses 32 for each ply. The ply data and course definitions are then used at 64 to construct a cost function at 66. The cost function computes the cost of the travel between doublers 22. This cost function may be quantified in terms of travel distance and/or time that the tape head 14 remains off-part.

At step 68, an initial ordering of the doublers 22 is performed. This initial ordering may include determining the start and stop points for each doubler, as shown at 67. The ordering performed at step 68 includes selection of start and stop gates for each doubler 22 as well as one possible or optional path of travel between the doublers. Using the initial ordering selected at step 68, the travel cost between doublers is computed at step 70. Next, at step 72, the doubler ordering assignment is analyzed at step 72, and the off-part motion for the initial ordering is analyzed at step 74. The off-part motion analysis may include calculating the time required to complete the layup, as shown at 75. Based on the analysis performed at steps 72, 74 and 75, options are analyzed for reordering the doublers at step 76. Based on the analysis at step 76, the ordering may be revised at step 77 following which the travel cost is recomputed at step 70. The process of revising the ordering at 77 and recalculating the travel cost at 70, as well as steps 72, 74 and 75 is repeated until the travel cost is minimized. When the doubler ordering has been optimized at step 76, the doubler ordering assignment is output at step 78 which may then be used to develop a set of programmed instructions for optimizing tape head 14 travel.

Another method embodiment is illustrated in FIG. 11. Beginning at step 63, optional tape head travel paths between doublers in a sequence are first analyzed. At 65, the non-productive motion of the tape head during travel between the doublers is identified for each of the optional travel paths analyzed at 63. The identification of non-productive motion may include determining at step 69, the length of time or the distance required by the tape head to move between the doublers. Alternatively, as shown at step 71, the identification of non-productive motion may comprise determining the length of time that tape is not being laid down by the tape head. At step, 73, a travel path is selected that minimizes the nonproductive motion that has been previously identified at step 65. Finally, at step 79, a set of machine readable instructions are generated that may be used for automatically controlling the tape head.

Referring now to FIG. 12, the disclosed method may be implemented by programmed instructions forming a motion optimizer program 82. One or more tape laydown machines 12 may be operated by an NC controller 80. The NC controller 80 controls motions of the tape head 14 as well as other functions of the laydown machine 12, such as tape feed, tape cut-off (not shown) etc. The NC controller 80 may include a set of programmed instructions which control the machine movements, including the path of travel of the tape head 14. These programmed instructions may be produced by an NC path generation program 90, such as that disclosed in U.S. patent application Ser. No. 11/269,905 filed Nov. 9, 2005; U.S. patent application Ser. No. 11/315,101 filed Dec. 23, 2005 and published as US-2007-0144676-A1 on Jun. 28, 2007; and U.S. patent application Ser. No. 11/815,103, filed Dec. 23, 2005 and published as US-2007-0150087-A1 on Jun. 28, 2007, the entire disclosures of which are incorporated by reference herein.

The NC path generation program 90 generates the programmed instructions used by the NC controller 80 based on a set of CAD files 94 which may define the composite part 10 in terms of sequences containing doubler plies of the composite tape. As previously mentioned, the sequences generally represent layers of a composite material that form the composite part, and ply doublers generally represent a region of a composite material layer. In the CAD data format, for example, each doubler ply may be modeled as a boundary on a complex surface, with associated material and orientation properties. A CAD file interface 92 may be used to convert the composite part definition data format unique to a specific CAD system that is compatible with the NC path generation program 90. Based on the composite part surface definition and doubler ply definitions, the NC path generation program 90 produces a set of programmed instructions that define the paths to be followed by the tape head 14.

The order optimizer program 82 may comprise a set of programmed instructions that are utilized directly by the NC controller 80, as indicated by the broken arrow path 84. Alternatively, a computer 86 may utilize the program 82 to alter the NC path generation program 90 or to alter the programmed instructions which control the NC controller 80. An operator input/output device 88 may be provided, which may comprise, for example, and without limitation, a keyboard and/or display.

Embodiments of the disclosure may find use in a variety of potential applications, particularly in the transportation industry, including for example, aerospace and automotive applications. Thus, referring now to FIGS. 13 and 14, embodiments of the disclosure may be used in the context of an aircraft manufacturing and service method 96 as shown in FIG. 13 and an aircraft 98 as shown in FIG. 14. Aircraft applications of the disclosed embodiments may include, for example, without limitation, composite stiffened members such as fuselage skins, wing skins, control surfaces, hatches, floor panels, door panels, access panels and empennages, to name a few. During pre-production, exemplary method 96 may include specification and design 98 of the aircraft 116 and material procurement 100. During production, component and subassembly manufacturing 102 and system integration 104 of the aircraft 98 takes place. Thereafter, the aircraft 98 may go through certification and delivery 106 in order to be placed in service 108. While in service by a customer, the aircraft 98 is scheduled for routine maintenance and service 110 (which may also include modification, reconfiguration, refurbishment, and so on).

Each of the processes of method 96 may be performed or carried out by a system integrator, a third party, and/or an operator (e.g., a customer). For the purposes of this description, a system integrator may include without limitation any number of aircraft manufacturers and major-system subcontractors; a third party may include without limitation any number of venders, subcontractors, and suppliers; and an operator may be an airline, leasing company, military entity, service organization, and so on.

As shown in FIG. 143, the aircraft 98 produced by exemplary method 96 may include an airframe 112 with a plurality of systems 114 and an interior 116. Examples of high-level systems 114 include one or more of a propulsion system 118, an electrical system 122, a hydraulic system 120, and an environmental system 124. Any number of other systems may be included. Although an aerospace example is shown, the principles of the disclosure may be applied to other industries, such as the automotive industry.

Apparatus and methods embodied herein may be employed during any one or more of the stages of the production and service method 96. For example, components or subassemblies corresponding to production process 102 may be fabricated or manufactured in a manner similar to components or subassemblies produced while the aircraft 116 is in service. Also, one or more apparatus embodiments, method embodiments, or a combination thereof may be utilized during the production stages 102 and 104, for example, by substantially expediting assembly of or reducing the cost of an aircraft 96. Similarly, one or more of apparatus embodiments, method embodiments, or a combination thereof may be utilized while the aircraft 96 is in service, for example and without limitation, to maintenance and service 110.

Although the embodiments of this disclosure have been described with respect to certain exemplary embodiments, it is to be understood that the specific embodiments are for purposes of illustration and not limitation, as other variations will occur to those of skill in the art.

What is claimed is:

1. A method for optimizing automated laydown of a plurality of composite doublers used in a composite structure layup, comprising the steps of:
(A) selecting an order in which an automated composite tape laydown head may laydown the doublers;
(B) determining a cost associated with the travel of the tape head required to complete laydown of the doublers using the order selected in step (A); and,
(C) revising the order selected in step (A) in an manner to minimize the cost determined in step (B).

2. The method of claim 1, wherein step (B) includes determining the total distance traveled by the tape head to complete laydown of the doublers using the order selected in step (A).

3. The method of claim 1, wherein step (B) includes determining the total time required for the tape head to complete laydown of the doublers using the order selected in step (A).

4. The method of claim 1, wherein:
step (C) includes repeatedly changing the order in which the tape head may laydown the doublers, and
step (B) includes determining the cost for the order each time the order is changed.

5. The method of claim 1, wherein step (A) is performed using a set of data defining plies and tape courses used to form the layup.

6. The method of claim 1, wherein step (A) includes determining, for each of the doublers, the points at which the tape head starts and stops tape laydown.

7. The method of claim 1, further comprising the step of:
(E) generating a set of programmed instructions for controlling the movements of tape head using the revised order for laying down the doublers.

8. A composite aircraft subassembly fabricated by a tape laydown machine optimized by the method of claim 1.

9. Fabricating a vehicle assembly using a tape laydown machine optimized by the method of claim 1.

10. A method of optimizing the operation of an automated tape laydown head used to fabricate a composite structure in which composite tape is laid down in sequences each including a plurality of ply doublers, comprising the steps of:
(A) analyzing optional paths of travel of the tape head between the doublers in a sequence;
(B) identifying non-productive motion of the tape head during travel between the doublers for each of the optional travel paths analyzed in step (A);
(C) selecting a travel path analyzed in step (A) that minimizes the non-productive motion of the tape head; and,
(D) generating a set of machine readable instructions used for automatically controlling the tape head based on the path of travel selected in step (C).

11. The method of claim 10, wherein step (B) includes determining the length of time that the tape head is not laying down tape.

12. The method of claim 10 wherein step (B) includes determining the length of time required by the tape head to move between doublers.

13. The method of claim 10, wherein step (B) includes determining the total distance traveled by the tape head during movement between the doublers.

14. The method of claim 10, further comprising the step of:
(E) for each of the doublers, selecting a starting gate position and a stopping gate position.

15. The method of claim 10, wherein step (C) includes selecting an order in which the tape head moves between the doublers.

16. The method of claim 10, wherein step (A) is performed using a set of data defining plies and tape courses used to form a sequence.

17. An aircraft subassembly fabricated by a tape laydown head optimized by the method of claim. 10.

18. Fabricating a vehicle assembly using a tape laydown head optimized by the method of claim 10.

19. A method for automatic control of a composite tape laydown head used to form composite ply doublers in a composite structure layup, comprising the steps of:
(A) selecting, for each doubler, the location of a starting gate and a stopping gate between which the tape head lays down courses of tape;
(B) using the gate locations selected in step (A), generating a plurality of possible courses of travel of the tape head between the doublers;
(C) determining the motions of the tape head required during travel of the tape head for each of the possible courses generated in step (B);
(D) identifying which of the possible courses of travel represents the least of amount of tape head motion determined in step (C); and,
(E) generating a set of machine readable instructions used for automatically controlling the tape head based on the course identified in step (D).

20. The method of claim 19, wherein step (C) includes determining the length of time that the tape head is not laying down tape.

21. The method of claim 19 wherein step (C) includes determining the length of time required by the tape head to move between doublers.

22. The method of claim 19, wherein step (D) includes determining the total distance traveled by the tape during movement between the doublers.

23. The method of claim 10, wherein step (B) is performed using a set of data defining plies and tape courses used to form the doublers.

24. An aircraft subassembly fabricated by a tape laydown head controlled by the method of claim 19.

25. Fabricating a vehicle assembly using a tape laydown head controlled by the method of claim 19.
